(19) United States
(12) Patent Application Publication
(10) Pub. No.: US 2019/0379186 A1
(43) Pub. Date: Dec. 12, 2019

(54) Cable Cleat for Trefoil Cable Arrangement

(71) Applicant: Panduit Corp., Tinley Park, IL (US)

(72) Inventors: Surendra Chitti Babu, Naperville, IL (US); Shaun P. Brouwer, St. John, IN (US)

(73) Assignee: Panduit Corp., Tinley Park, IL (US)

(21) Appl. No.: 16/431,149

(22) Filed: Jun. 4, 2019

Related U.S. Application Data
(60) Provisional application No. 62/682,518, filed on Jun. 8, 2018.

(51) Int. Cl. H02G 3/04

(52) U.S. Cl. CPC H02G 3/0406; H02G 3/0456

(57) ABSTRACT

A trefoil cable arrangement that secures cables during a short circuit event. The trefoil cable arrangement has a top cleat and a bottom cleat. The bottom cleat is secured to the top cleat to form the trefoil cable arrangement. The top cleat has an outer surface, an inner surface, and ends with mounting holes. The bottom cleat has an outer surface, an inner surface defining a cable support area, and ends with mounting holes. The cable support area is curved to support various sized cables.

### CROSS REFERENCE TO RELATED APPLICATIONS

This application claims priority to U.S. Provisional Application No. 62/682,518, filed Jun. 8, 2018, the subject matter of which is hereby incorporated by reference in its entirety.

### FIELD OF THE INVENTION

The present invention relates to cable cleats, and more particularly to a cable cleat for a trefoil cable arrangement.

### BACKGROUND OF THE INVENTION

Cable cleats or cleat assemblies are typically used to manage and secure 3-phase power cables of various sizes in a trefoil arrangement along a cable ladder or ladder rung. In addition to securing cables laterally and axially, cable cleats must be rigid enough to retain cables during short-circuit events, where electromagnetic forces can cause the cables to repel one another at extremely high forces. Cable cleats hold the cables in place during a short-circuit event to prevent damage to people and property.

There is a need for a cable management assembly that can be used to manage and secure 3-phase power cables, preferably in a trefoil arrangement, during a short-circuit event.

### SUMMARY OF THE INVENTION

A trefoil cable arrangement designed to secure cables during a short circuit event. The trefoil cable arrangement includes a bottom cleat secured to a top cleat. The top cleat has an outer surface, an inner surface, and ends with mounting holes. The bottom cleat has an outer surface, an inner surface defining a cable support area, and ends with mounting holes. The cable support area is curved to support cables of various sizes.

### BRIEF DESCRIPTION OF THE DRAWINGS

FIG. 1 is a perspective view of the trefoil cable cleat assembly of the present invention.

FIG. 2 is a perspective view of the trefoil cable cleat assembly of FIG. 1 secured to a ladder rack.

FIG. 3 is a top perspective view of the top cleat of the trefoil cable cleat assembly of FIG. 1.

FIG. 4 is a side perspective view of the top cleat of the trefoil cable cleat assembly of FIG.

FIG. 5 is a bottom perspective view of the top cleat of the trefoil cable cleat assembly of FIG. 1

FIG. 6 is an end view of the trefoil cable cleat assembly of FIG. 2.

FIG. 7 is a sectional view of top cleat of the trefoil cable cleat assembly of FIG. 6

FIG. 8 is a perspective view of the bottom cleat of the trefoil cable cleat assembly of FIG. 1.

FIG. 9 is a side view of the bottom cleat of the trefoil cable cleat assembly of FIG. 1.

FIG. 10 is a side view of the trefoil cable cleat assembly of FIG. 1 securing small diameter cables.

FIG. 11 is a side view of the trefoil cable cleat assembly of FIG. 1 securing large diameter cables.

FIG. 12 is a bottom perspective view of the bottom cleat of the trefoil cable cleat assembly of FIG. 1.

FIG. 13 is a perspective view of the trefoil cable cleat assembly of FIG. 1 secured to a ladder rung.

FIG. 13A is an end perspective view of the trefoil cable cleat assembly of FIG. 13.

FIG. 14 is an exploded view of the trefoil cable cleat assembly of FIG. 1 to be mounted to the ladder rung.

FIG. 15 is an exploded view of the trefoil cable cleat assembly of FIG. 1 to be mounted to the ladder rung.

FIG. 16 is a perspective view of an alternative embodiment of the trefoil cable cleat assembly of the present invention.

FIG. 17 is a perspective view of the top cleat of the trefoil cable cleat assembly of FIG. 16.

FIG. 18 is a side perspective view of the top cleat of the trefoil cable cleat assembly of FIG. 16.

FIG. 19 is a side perspective view of the inside surface of the top cleat of FIG. 17.

FIG. 20 is a perspective view of the inside surface of the top cleat of FIG. 17.

FIG. 21 is a perspective view of an alternative design of the top cleat of the trefoil cable cleat assembly of FIG. 16.

FIG. 22 is a side perspective view of the top cleat of FIG. 21.

FIG. 23 is a perspective view of an alternative design of the top cleat of the trefoil cable cleat assembly of FIG. 16.

FIG. 24 is a side perspective view of the top cleat of FIG. 23.

### DETAILED DESCRIPTION

The present invention is directed to trefoil cable cleats capable of securing three cables to a ladder rack. The trefoil cable cleat could be manufactured from many materials, however, the trefoil cable cleat is preferably manufactured from an injection molded polymer or cast metal.

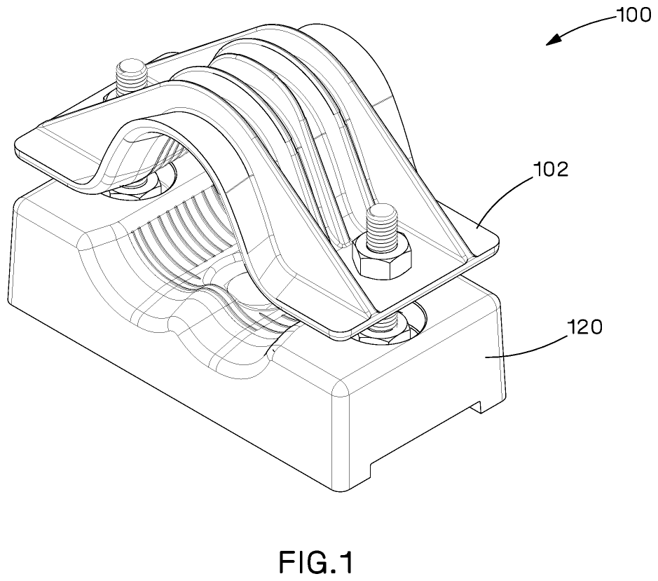

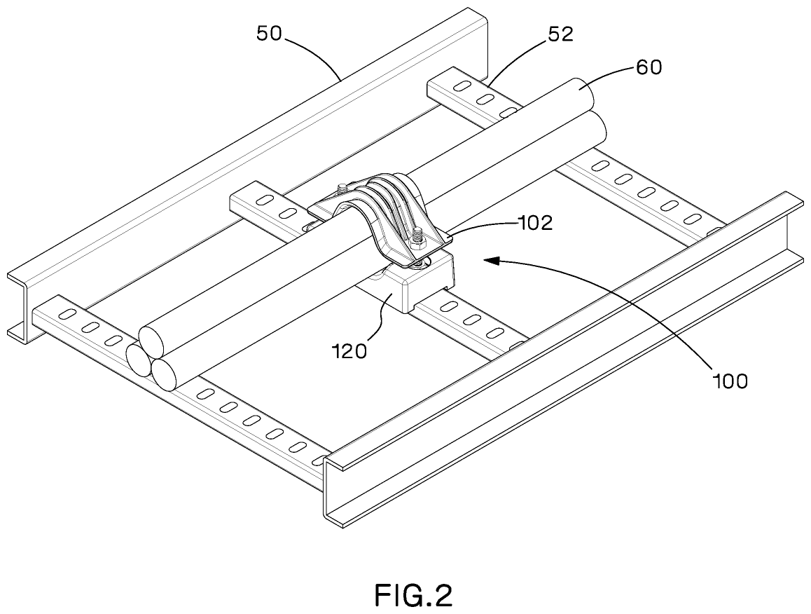

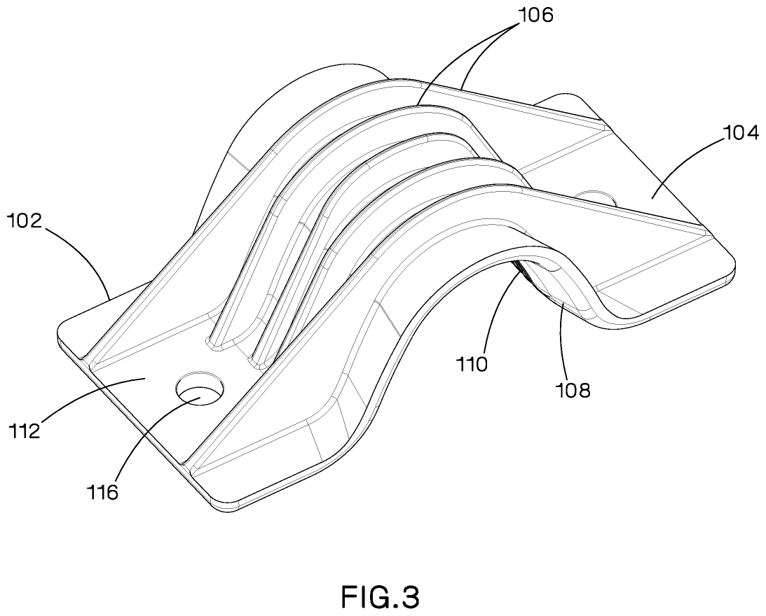

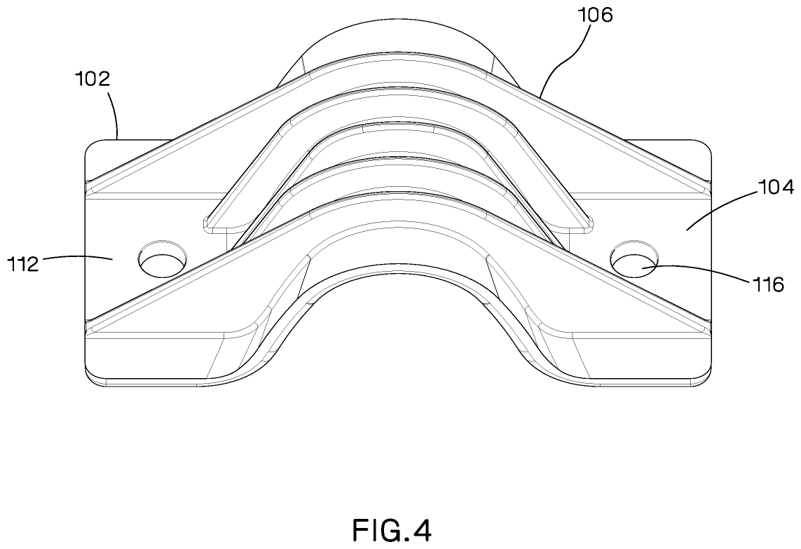

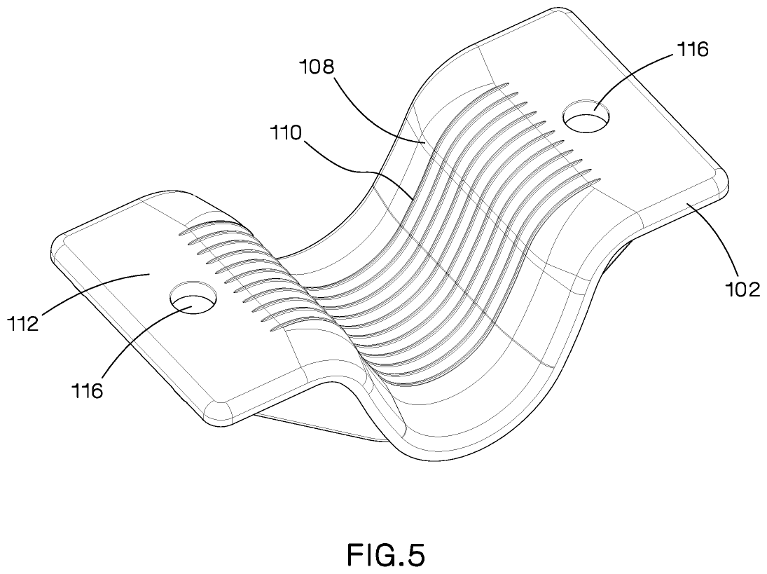

FIGS. 1-15 illustrate a first embodiment of the trefoil cable cleat 100 of the present invention. The trefoil cable cleat 100 includes a top cleat 102 and a bottom cleat 120. FIGS. 3-5 illustrate the top cleat 102. The top cleat 102 includes an outer surface 104, an inner surface 108, ends 112, and mounting holes 116. The outer surface 104 includes a plurality of strengthening ribs 106. The inner surface 108 includes a plurality of gripping ribs 110 for engaging the cables when the trefoil cable cleat is assembled. Each end 112 of the top cleat 102 includes a mounting hole 116 for receiving a fastener to secure the cable cleat.

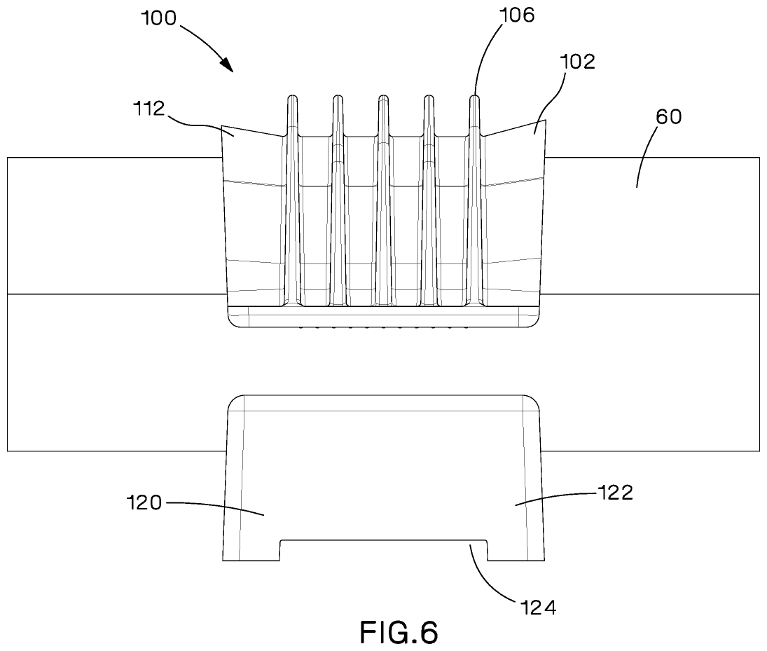

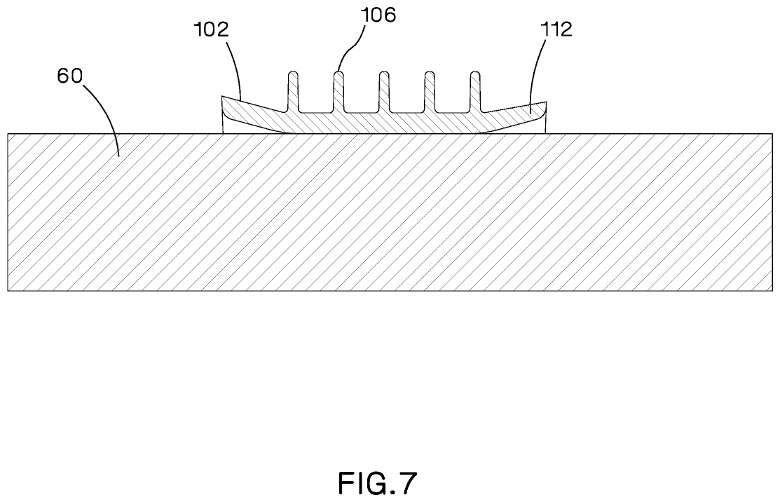

As illustrated in FIGS. 6-7, the ends 112 of the top cleat 102 flare out to protect cables. The flared ends 112 also provide space for the cables to spread out and increase the distance between the cables thereby reducing short circuit forces.

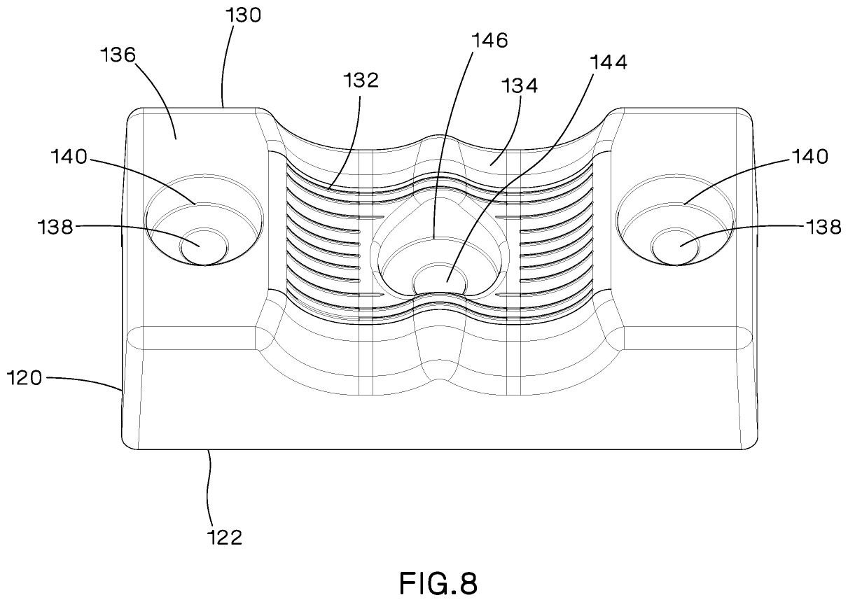

FIGS. 8-9 and 12 illustrate the bottom cleat 120. The bottom cleat 120 includes an outer surface 122, inner surface 130, and ends 136. The inner surface 130 includes a plurality of gripping ribs 132 for engaging the cables 60 when the trefoil cable cleat 100 is assembled.

The bottom cleat 120 also includes mounting holes 138, 144 and recessed pockets 140, 146 surrounding the mounting holes 138, 144. One mounting hole 138 and pocket 140 is positioned at each end 136 of the bottom cleat 120 and a mounting hole 144 and pocket 146 is positioned in the middle of the bottom cleat 120. The recessed pockets 140, 146 house nuts and bolt heads to prevent the fasteners from occupying extra space in the bottom cleat 120. This is beneficial when the smallest cables are installed where the top and bottom cleats can be almost in contact reducing the overall height of the assembly. Additionally, the pockets 140, 146 accommodate the socket heads for easy installation.

Similar to the top cleat 102, the bottom cleat 120 is flared in order to protect the cable cleat during a short circuit event. The flared bottom cleat 120 also allows the cables freedom to move away from each other thereby reducing short circuit forces.

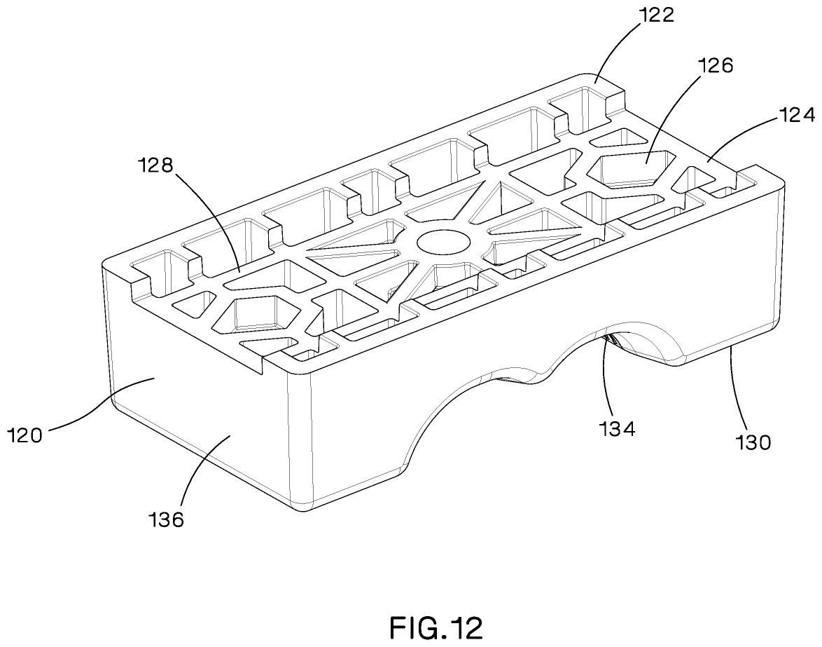

The outer surface 122 of the bottom cleat 120 is illustrated in FIG. 12. The outer surface 122 includes recessed ends 124 to enable the bottom cleat 120 to be positioned on a ladder rung 52. The ends of the outer surface 122 also include hex pockets 126 for facilitating the installation of fasteners in the mounting holes 138. The outer surface 122 also includes a plurality of strengthening ribs 128.

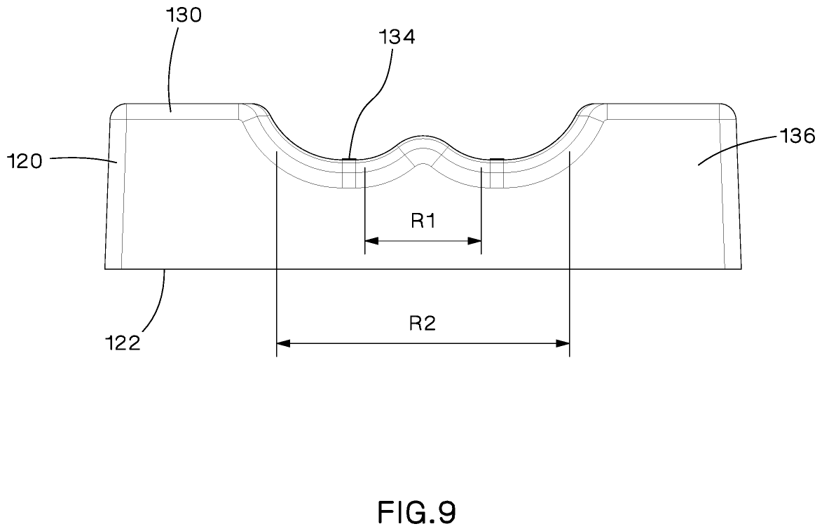

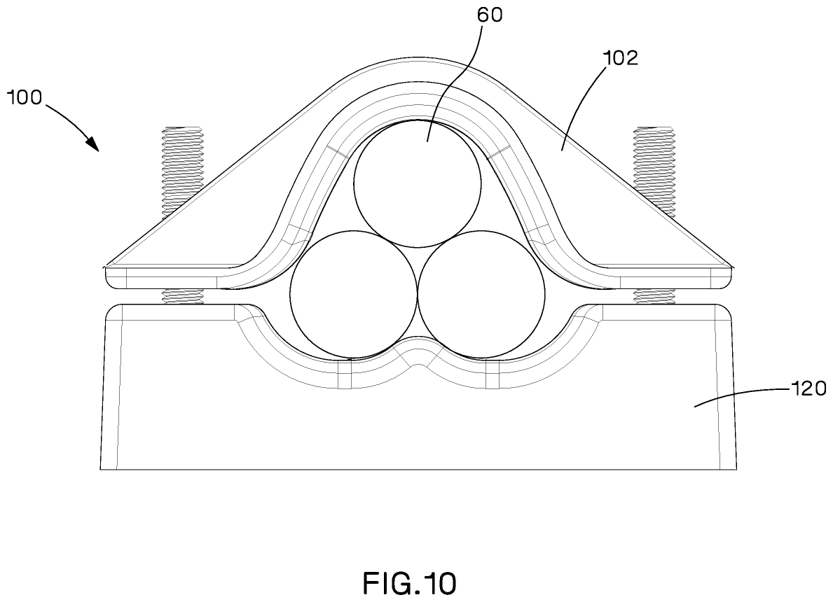

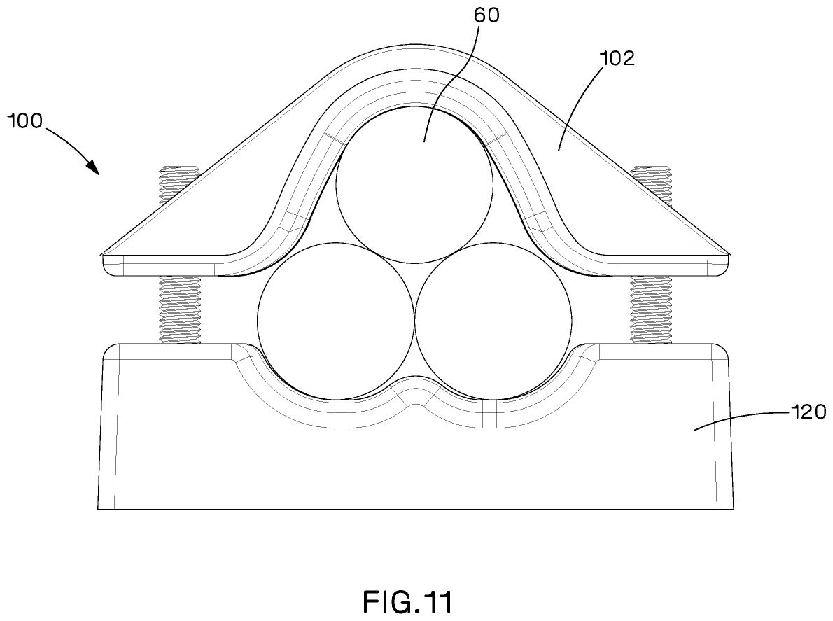

As illustrated in FIGS. 9-11, the inner surface 130 of the bottom cleat 120 includes a curved cable support area 134 to enable the bottom cleat 120 to receive a variety of cables sizes. The cable support area 134 supports cables ranging from a minimum radius R1 to cables having a maximum radius R2. Thus, the bottom cleat 120 used along with the top cleat 102, secures a range of cable diameters in a true contacting trefoil formation. FIG. 10 illustrates the trefoil cable cleat 100 securing the smallest diameter cables in perfect trefoil formation with the cables in contact with each other. FIG. 11 illustrates the trefoil cable cleat 100 securing the largest diameter cables in perfect trefoil formation with the cables in contact with each other.

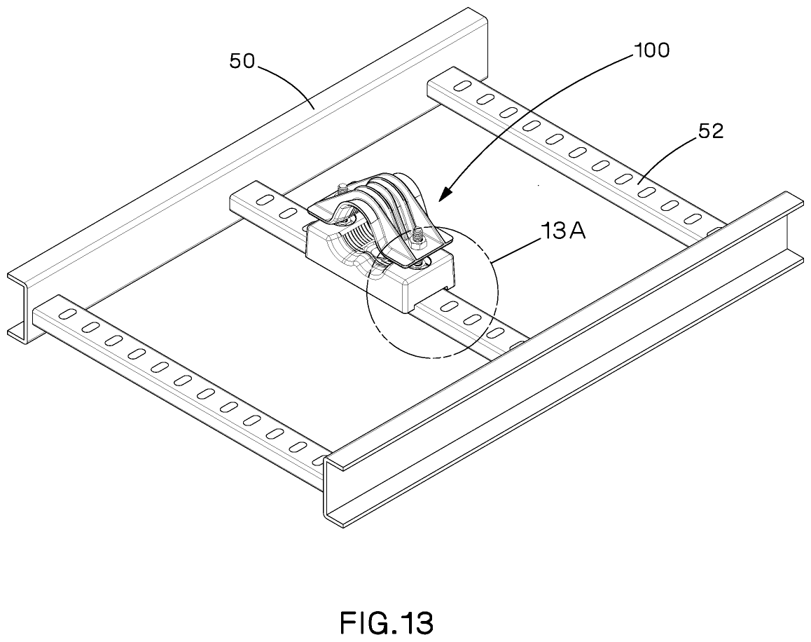

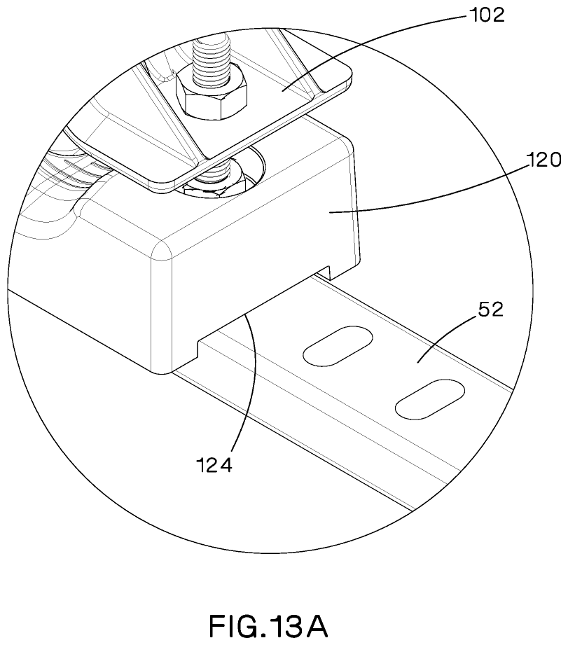

FIGS. 13-15 illustrate the trefoil cable cleat 100 being secured to the ladder rack 50. As illustrated FIGS. 13 and 13A, the bottom cleat 120 of the trefoil cable cleat 100 is positioned on the ladder rung 52 with the recessed ends 124 in the outer surface 122 receiving the ladder rung 52. The recessed ends 124 stabilize the placement of the trefoil cable cleat 100.

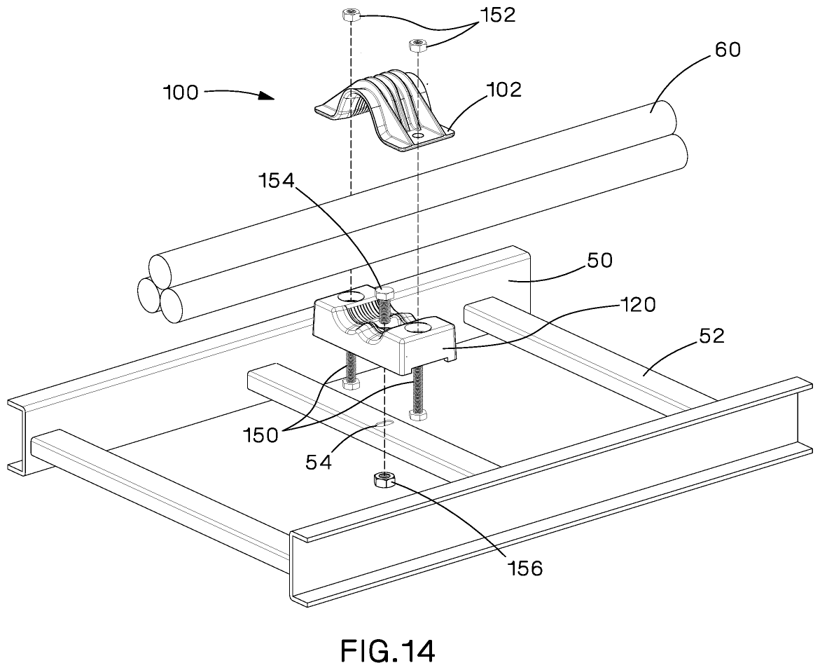

The trefoil cable cleat 100 can be secured to the cables 60 and a ladder rung 52 in two ways. As illustrated in FIG. 14, two bolts 150 are first positioned in the mounting holes 138 in the ends 136 of the bottom cleat 120. Next, the bottom cleat 120 is attached to the ladder rung 52 via a bolt 154 positioned through the middle mounting hole 144, ladder rung hole 54, and secured by a nut 156. The cables 60 can be laid on top of the bottom cleat 120 and the top cleat 102 is positioned over the cables 60. The bolts 150 extending through the end holes 138 in the bottom cleat 120 extend through the mounting holes 116 in the ends 112 of the top cleat 102 and are secured thereto via nuts 152.

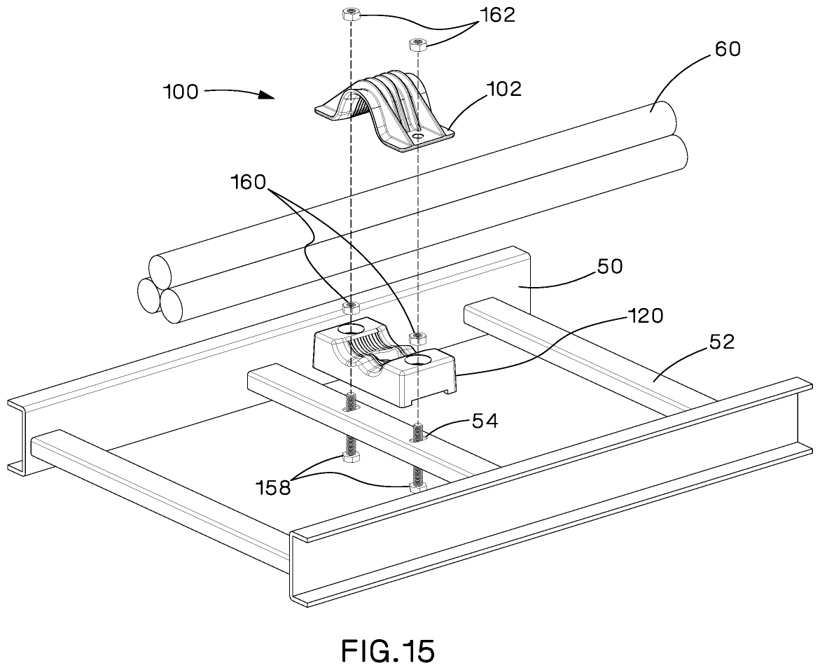

FIG. 15 illustrates the second mounting method. First, two long bolts 158 are feed through the ladder rung holes 54 and the mounting holes 138 at the ends 136 of the bottom cleat 120. Nuts 160 are used to secure the bottom cleat 120 to the ladder rung 52. Next, cables 60 are laid on top of the bottom cleat 120 and the top cleat 102 is positioned over the cables 60. The bolts 158 extend through the mounting holes 116 at the ends 112 of the top cleat 102. A separate pair of nuts 162 secures the top cleat 102 to the bottom cleat 120 and ladder rung 52.

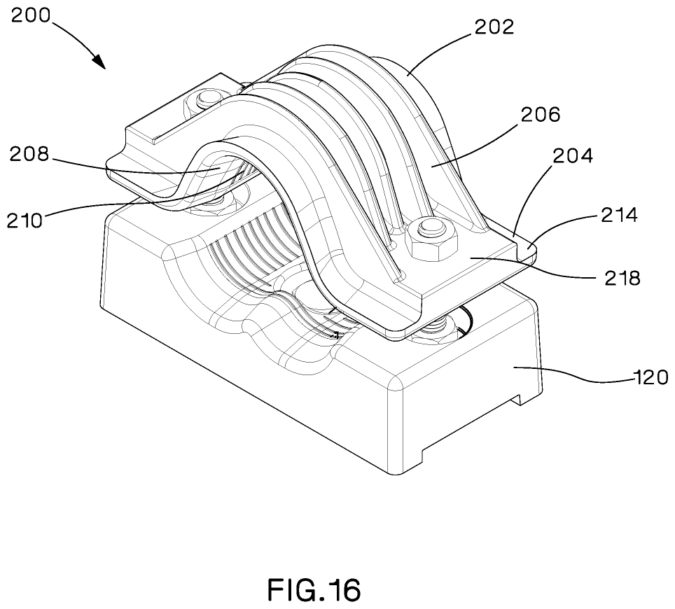

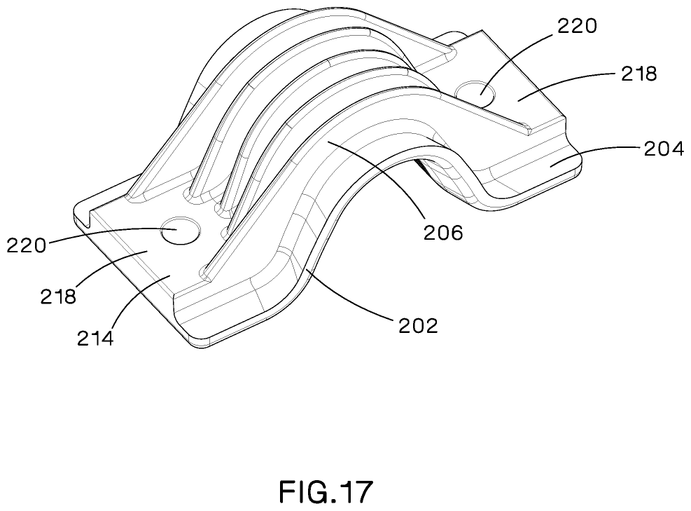

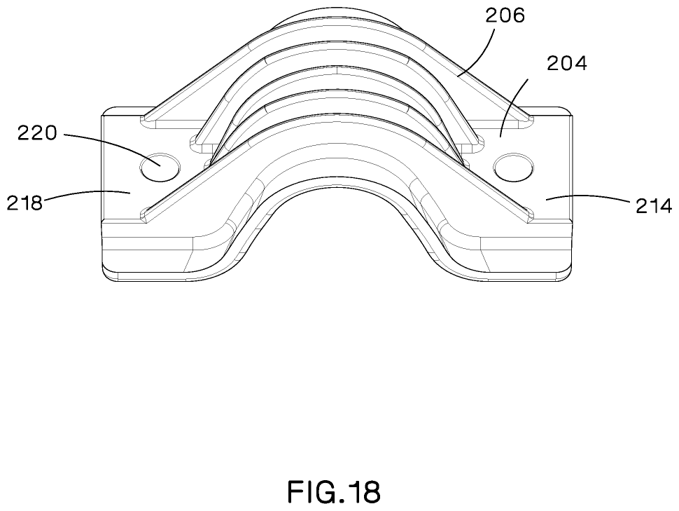

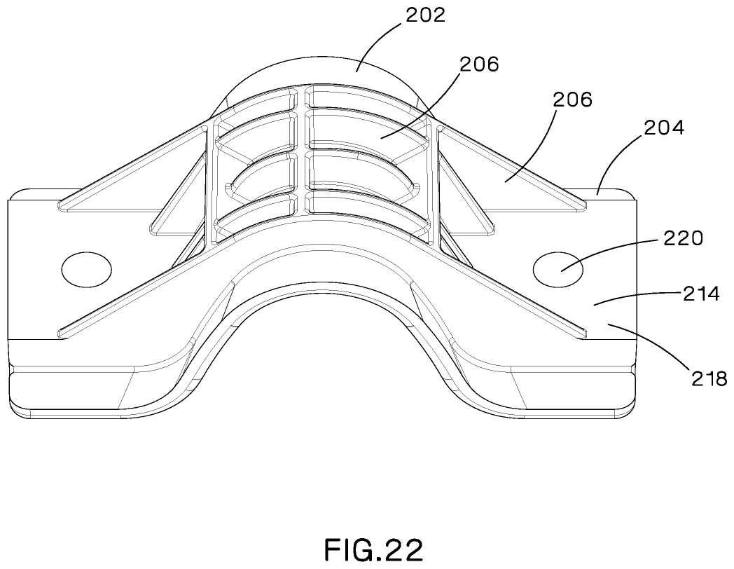

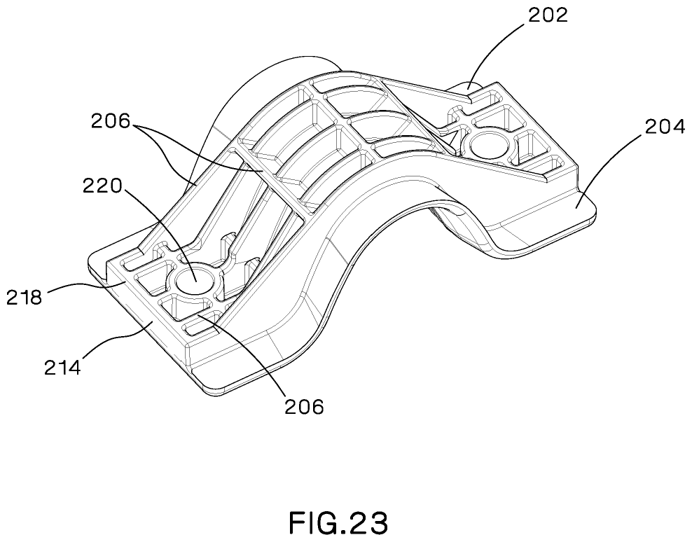

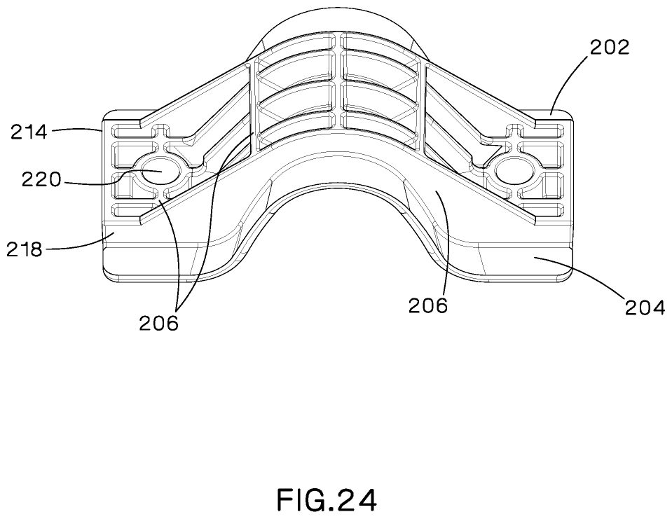

FIGS. 16-24 illustrate a second embodiment of a trefoil cable cleat 200 of the present invention. A top cleat 202 is used with the bottom cleat 120 to form the trefoil cable cleat 200. The top cleat 202 includes an outer surface 204, an inner surface 208, and ends 214. The outer surface 204 includes a plurality of strengthening ribs 206.

The ends 214 include a rectangular raised or protruding member 218. As discussed above, during a short circuit event, the cables flex and move around with significant forces. The mounted ends 214 could be under substantial stress during a short circuit event and the top cleat 202 could break off at this location. The raised member 218 at the ends 214 reinforces the mounted ends to improve the strength of the top cleat 202.

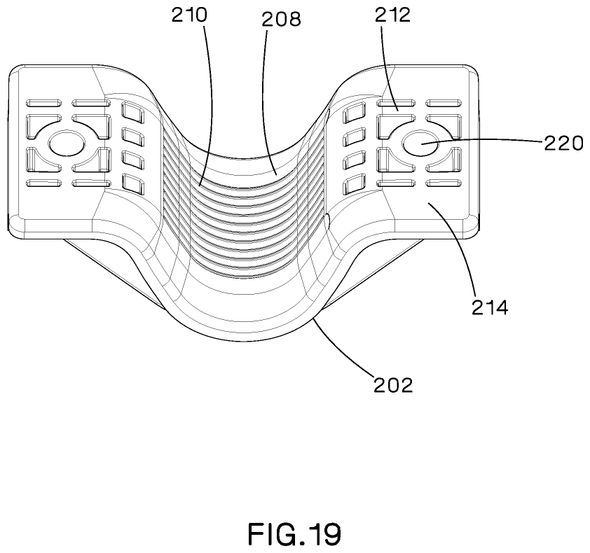

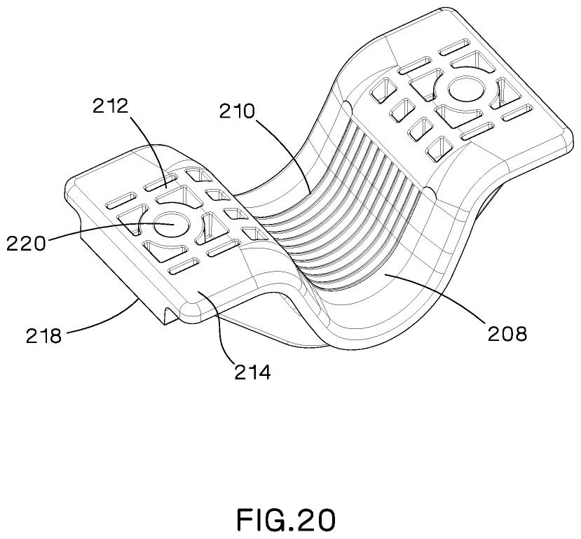

The inner surface 208 of the top cleat 202 includes a plurality of gripping ribs 210 for engaging the cables when the trefoil cable cleat 200 is assembled. The inner surface 208 also includes a plurality of strengthening ribs 212 at the ends 214 to reinforce the raised member 218 (see FIGS. 19-20).

Each end 214 of the top cleat 202 includes a mounting hole 220 for receiving a fastener to secure the cable cleat. Similar to the top cleat 102 discussed above, the ends 214 of the top cleat 202 flare out to protect the cables. The flared ends 214 also provide space for the cables 60 to spread out and increase the distance between the cables thereby reducing short circuit forces.

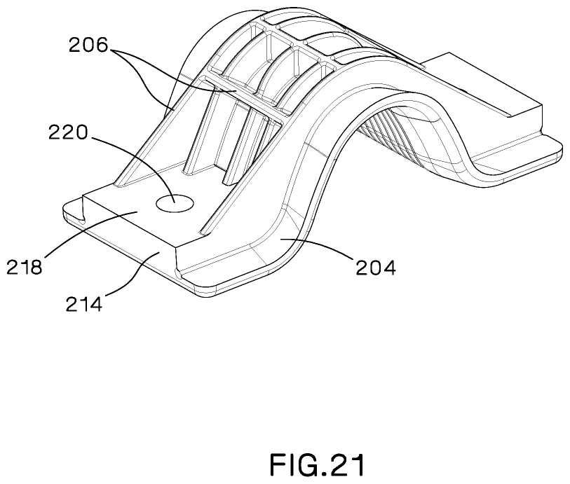

FIGS. 21-24 illustrate the top cleat with different patterns of strengthening ribs. The additional strengthening ribs are provided to improve the strength of the top cleat, when desired.

The top cleat 202 and the bottom cleat 120 are assembled to form a trefoil cable cleat 200 in the same manner as described above with respect to the trefoil cable cleat 100 and as illustrated in FIGS. 14 and 15.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation.

1. A trefoil cable arrangement for securing cables during a short circuit event, the trefoil cable arrangement comprising:
a top cleat having an outer surface, an inner surface, and ends with mounting holes; and a bottom cleat having an outer surface, an inner surface defining a cable support area, and ends with mounting holes, wherein the cable support area is curved to support cables having a range of radius;
whereby the bottom cleat is secured to the top cleat to form the trefoil cable arrangement.

2. The trefoil cable arrangement of claim 1, wherein the top cleat and the bottom cleat flare outwards for providing space to enable the cables to expand during a short circuit event.

3. The trefoil cable arrangement of claim 1, wherein the bottom cleat has recessed pockets for housing fasteners and reducing a height of the trefoil cable arrangement.

4. The trefoil cable arrangement of claim 1, wherein the outer surface of the bottom cleat has recessed ends for enabling the bottom cleat to be positioned on a ladder rung.

5. The trefoil cable arrangement of claim 1, wherein the outer surface of the bottom cleat having hex pockets for facilitating the installation of fasteners in the mounting holes.

6. The trefoil cable arrangement of claim 1, wherein the outer surface of the top cleat and the outer surface of the bottom cleat have strengthening ribs; and the inner surface of the top cleat and the inner surface of the bottom cleat have gripping ribs for engaging cables.

7. The trefoil cable arrangement of claim 1, wherein the bottom cleat further comprising a middle mounting hole and a recessed pocket surrounding the middle mounting hole; and wherein the trefoil cable arrangement is secured to cables and a ladder rung by positioning end fasteners in mounting holes in the ends of the bottom cleat; attaching the bottom of the cleat to the ladder rung by a fastener positioned through the middle mounting hole in the bottom cleat; positioning cables on the bottom cleat; positioning the top cleat over the cables; and positioning the end fasteners through the mounting holes at the ends of the top cleat.

8. The trefoil cable arrangement of claim 1, wherein the trefoil cable arrangement is secured to cables and a ladder rung by installing end fasteners through holes in a ladder rung and mounting holes in the ends of the bottom cleat; positioning cables on the bottom cleat; positioning the top cleat over the cables; and positioning the end fasteners through the mounting holes at the ends of the top cleat.

9. The trefoil cable arrangement of claim 1, wherein each end of the top cleat includes a raised member for reinforcing the ends of the top cable cleat.
